(19) United States
(12) Patent Application Publication
(10) Pub. No.: US 2026/0208908 A1
(43) Pub. Date: Jul. 23, 2026

(54) STAMP-FASHION SIGNATURE STICKER MACHINE STRUCTURE

(71) Applicant: Unicorn International Trading Limited, Kowloon (HK)

(72) Inventor: WEN-PIN SU, Kowloon (HK)

(21) Appl. No.: 19/035,795

(22) Filed: Jan. 23, 2025

(51) Int. Cl. B65C 9/26

(52) U.S. Cl. CPC B65C 9/262

(57) ABSTRACT

A stamp-fashion signature sticker machine structure includes a machine body and signature stickers received in the machine body. The machine body includes a stationary seat and a movable seat. A sticker tray is received in the movable seat. A constraining portion is arranged on an inner edge of a bottom of the sticker tray. Elastic elements are arranged between the movable seat and the stationary seat. The signature stickers are respectively provided, on a bottom thereof, with glue application layers arranged at different angles. A stack of sticker is placed in the sticker tray. The machine body is pressed down to cause the movable seat to move upward so as to have the sticker tray protrude out from the bottom of the movable seat to have the signature sticker attached to an object.

### BACKGROUND OF THE INVENTION

### Technical Field of the Invention

The present invention relates to a stamp-fashion signature sticker machine structure, and more particularly to a stamp-fashion signature sticker machine that performs a stamping like operation through a pressing operation to stick and attach a signature sticker to various objects for signature or marking to be made thereon.

### Description of the Prior Art

Signature stickers are a type of sticker that can be stuck and attached to an object to allow signatures to be made on the position where the sticker is attached, serving to identify the signature position of the object in order to prevent mis-signing. Signature stickers that are conventionally available in the market are usually made by applying adhesive to the other side of a sticker sheet with different patterns or logos printed thereon to provide stickiness, and multiple stickers are then arranged and stuck to an oily paper sheet having a surface on which oil is placed, so that users can pick up and tear off the stickers and stick them to the desired location. The conventional signature stickers usually have a glue on the top edge in order to allow multiple signature stickers to combine together in a stacked form, allowing the stickers to be torn off one by one for use. This is not only troublesome and time-consuming in production, but also inconvenient for users to carry or use. The signature stickers themselves are only attached to the object by a portion of the glue, which is not secure enough and easy to fall off. However, there is no better way to change the way of using signature stickers. For the vast signature sticker market, it is indeed something that sticker manufacturers should think about developing.

In view of this, the applicant, after continuous research and experiments, came up with the idea of designing a stamp-fashion signature sticker machine structure, which allows the signature stickers to be used to attach to an object by a pressing operation, just like stamping, making the use of signature stickers more convenient and more interesting.

### SUMMARY OF THE INVENTION

The primary objective of the present invention is to provide a stamp-fashion signature sticker machine structure, which allows signature stickers to be manipulated through a stamping like pressing operation to stick and attach the signature stickers to an object, making the use of the signature stickers more convenient and more interesting.

The aforementioned stamp-fashion signature sticker machine structure comprises a machine body and signature stickers received in the machine body. The machine body is provided, in an interior thereof, with a stationary seat and a movable seat that is movable, and a sticker tray penetrating into and received in the movable seat. The sticker tray is provided with constraining portions on an inner edge of a bottom thereof. Elastic elements are arranged between the movable seat and the stationary seat. The signature stickers are respectively provided, on a bottom surface thereof, with glue application layers that are uniformly distributed and arranged at different angles. The signature stickers are stacked and deposited in the sticker tray. By pressing the machine body, the movable seat is caused to move upwards so as to have the sticker tray protrude from the bottom of the movable seat to stick and attach the signature sticker to an object. The constraining portions separate the stuck signature sticker from the other signature stickers so as to achieve a sticking and attaching operation of the signature sticker in a manner like stamping to provide an indication to the position on the object where a signature is to be placed.

In the aforementioned stamp-fashion signature sticker machine structure, the machine body is provided with a fixing hole formed in each of two ends thereof and adjacent to a top edge to allow a top cover that is provided with retention hooks on two ends thereof to use the retention hooks to hook on the fixing holes in order to fix the top cover on the machine body.

In the aforementioned stamp-fashion signature sticker machine structure, the stationary seat is provided with positioning notch portions respectively on two sides thereof, and the movable seat is provided with flange portions respectively on two sides thereof and extending outwards by a predetermined width. The flange portion is provided with grooves formed in two ends thereof. Two elastic elements are mounted on the flange portions and the two elastic elements are generally of a successively folded configuration having a bottom fixed to the flange portion of the movable seat and positioned by means of the grooves on two ends of the flange portion. Tops of the elastic elements are supported on the positioning notch portions on two sides of the stationary seat.

In the aforementioned stamp-fashion signature sticker machine structure, the signature sticker comprises a top on which a marking layer is arranged and a bottom on which a glue application layer is arranged. The glue application layer is provided with a plurality of uniformly distributed glue spots. The glue spots of each of the signature stickers is arranged at a different angle, so that the different angles make the glue spots of the upper and lower signature stickers shifted away from each other to facilitate stably stacking and separation.

In the aforementioned stamp-fashion signature sticker machine structure, the signature stickers are set with different colors, and a number of sticker trays are provided. Signature stickers of different colors are deposited in different one of the sticker trays to allow the sticker trays to be changed according to different persons placing the signature or different documents.

### BRIEF DESCRIPTION OF THE DRAWINGS

FIG. 1 is a perspective view of the present invention.

FIG. 2 is an exploded view of the present invention.

FIG. 3 is a cross-sectional of the present invention.

FIG. 4 is a perspective view showing a signature sticker according to the present invention.

FIGS. 5A, 5B, and 5C are schematic views showing examples of distribution of a glue application layer of the signature sticker according to the present invention.

FIGS. 6 and 7 are schematic views illustrating disposition of stickers according to the present invention.

FIGS. 8, 9, 10, and 11 are schematic views illustrating operation of the present invention.

### DETAILED DESCRIPTION OF THE PREFERRED EMBODIMENTS

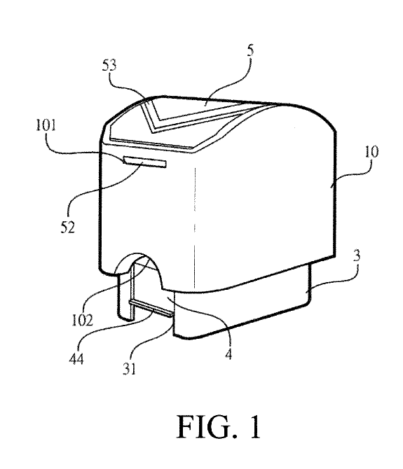

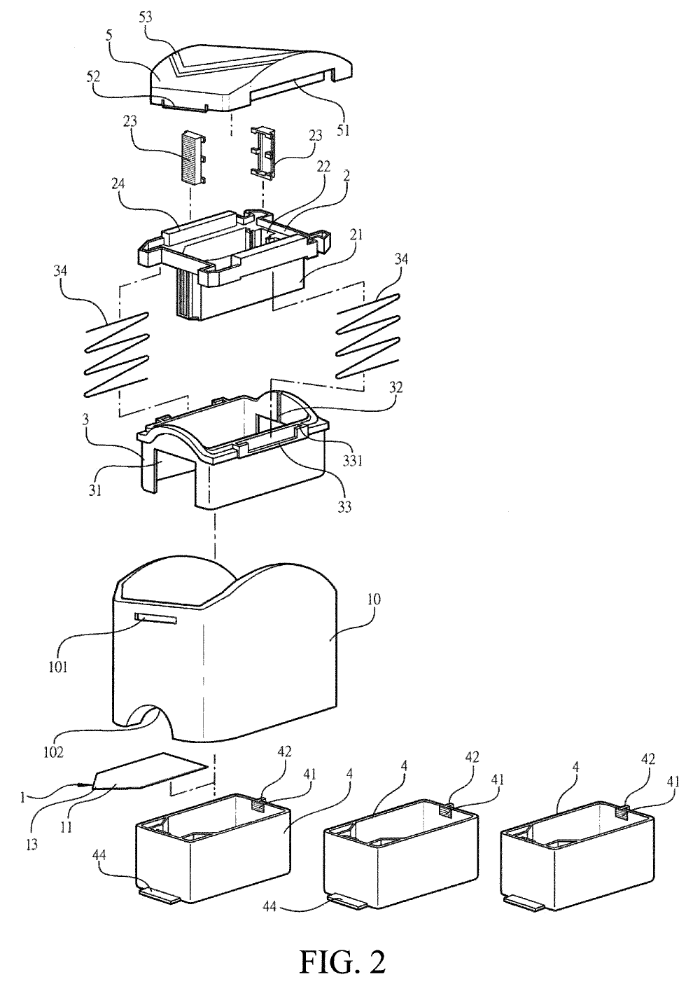

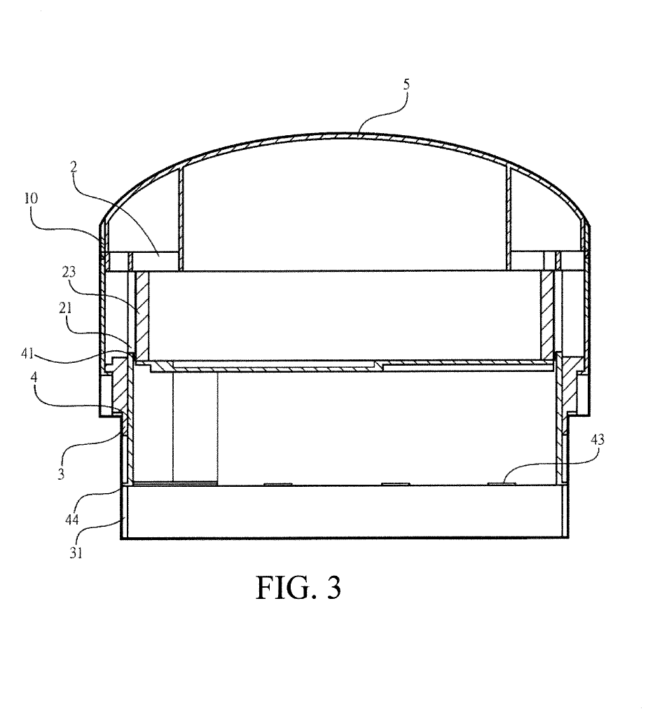

Referring to FIGS. 1 and 2, in combination with FIG. 3, which are respectively a perspective view and an exploded, and a cross-sectional view, of the present invention, as shown in the drawings, the present invention comprises a machine body 10 and signature stickers 1 receivable in the machine body 10. The machine body 10 receives and holds, in the interior thereof, a stationary seat 2, a movable seat 3, a plurality of sticker trays 4, and a top cover 5. The machine body 10 is provided with a fixing hole 101 formed in each of two ends thereof at a location close to a top edge and a notch 102 of a semi-circular configuration formed in a lower edge.

The stationary seat 2 comprises a pressing portion 21 corresponding in shape to the signature stickers 1. A fitting groove 22 of a generally T-shape is formed in each of two ends of the pressing portion 21. Two toothed racks 23 of a generally T-shape are respectively received in the fitting grooves 22, such that toothed portions of the toothed racks 23 face outwards. Two sides of the stationary seat 2 are each provided with a positioning notch portion 24.

The movable seat 3 is fit to the pressing portion 21 of the stationary seat 2 and is made in the form of a frame having two ends each of which comprises an opening 31 formed in a lower edge thereof and comprising a sliding groove 32 formed in one of the ends at an upper, inside edge of the opening 31 to extend vertically upward from the opening 31, and also having two sides each comprising a flange portion 33 extending outwards by a predetermined width, where two ends of the flange portion 33 are each formed with a groove 331, so that two elastic elements 34 are respectively mounted to the flange portions 33. The two elastic elements 34 are each of a successively folded configuration having a bottom fixed to a corresponding one of the flange portions 33 of the movable seat 3 and positioned by the grooves 331 in the two ends of the flange portion 33. Tops of the elastic elements 34 respectively engage with and supported on the positioning notch portions 24 on the two sides of the stationary seat 2.

The plurality of sticker trays 4 each receive and hold therein a predetermined number of signature stickers 1, and are selectively fit to the movable seat 3 to be movable upward/downward along the movable seat 3, and have two ends which are each provided, on an inner edge thereof, with a toothed portion 41, so that the toothed portions 41 are respectively engageable with the two toothed racks 23 of the stationary seat 2, and are provided, on an outer side of one end thereof, with a positioning tab 42, so that the positioning tab 42 is received in the sliding groove 32 of the movable seat 3 for positioning during the movement of the sticker tray 4. The sticker tray 4 is provided, on inner edges of the bottom at two sides thereof, with a plurality of constraining portions 43 extending horizontally inwards by a predetermined length, and is also provided with a stop plate 44 on an outer side of each of two ends thereof, so that the stop plates 44 are respectively located in the openings 31 of the movable seat 3 for constraining purposes.

The top cover 5 has two sides on each of which an elongate notch 51 is provided, two ends on each of which a retention hook 52 is provided, and a surface on which an arrow mark 53 is formed.

With the above-described components, to assemble the present invention, the stationary seat 2 and the movable seat 3 having the elastic elements 34 connected thereto, and the sticker tray 4 are disposed into the machine body 10, and then the top cover 5 is set on and covers the top of the machine body 10, such that the elongated notches 51 are fit to the positioning notch portions 24 of the stationary seat 2, and the retention hooks 52 hook on and engage with the fixing holes 101 of the machine body 10 to fix the top cover 5 on the machine body 10, thereby forming a stamp-fashion signature sticker machine.

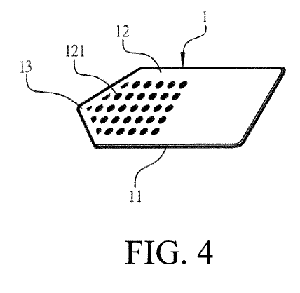

Referring to FIG. 4, which is a perspective view showing a signature sticker of the present invention, as shown in the drawing, a predetermined number of signature stickers 1 according to the present invention are first stacked together and deposited in the sticker tray 4. The signature sticker 1 is of a rectangular shape having one end that forms a sharp, arrow-like tip portion 13. The signature sticker 1 comprises a marking layer 11 on the surface and a glue application layer 12 on the bottom. The glue application layer 12 is provided with a plurality of glue spots 121 uniformly distributed. In the instant embodiment, the signature sticker 1 comprises a polyethylene terephthalate (PET) material; the marking layer 11 contains text marking or pattern; the glue spots 121 are uniformly distributed dots of dispensed glue material. Further; in the instant embodiment, the signature stickers 1 are provided in different colors, so that different colors of signature stickers 1 can be used according to different objects to be signed.

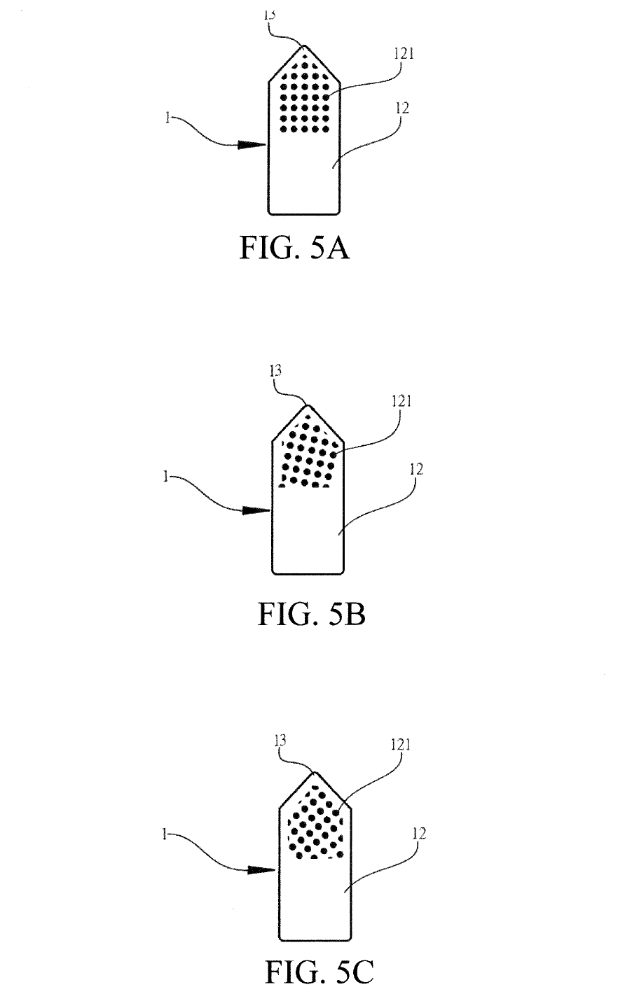

Referring to FIGS. 5A, 5B, and 5C, which are schematic views showing examples of distribution of the glue application layer of the signature sticker according to the present invention, as shown in the drawings, to prevent the glue spots 121 of the glue application layers 12 of the signature stickers 1 according to the present invention from being set on the same position when stacked, the arrangement of the glue spots 121 is set at a different angle, so that by means of such different angles, the glue spots 121 on an upper signature sticker and those on a lower one are shifted away from each other and staggered with respect to each other, in order to facilitate stable stacking and separating, such as 0 degree shown in FIG. 5A, 72 degrees shown in FIG. 5B, and 216 degrees shown in FIG. 5C. In a preferred embodiment of the present invention, these angles can be set at 0 degree, 36 degrees, 72 degrees, 144 degrees, 180 degrees, 216 degrees, 252 degrees, and 288 degrees.

To use the present invention, the machine body 10 is pressed down to cause the movable seat 3 to move upward relative thereto, so as to have the sticker tray 4 exposed out of the bottom of the movable seat 3 to have the signature sticker 1 stuck and attached to an object. By means of the constraining portions 43, the signature sticker 1 that is stuck and attached to the object is separated from the other signature stickers 1, so that a sticking and attaching operation can be performed on the signature sticker 1 in such a way that is similar to stamping a seal. The use of the signature sticker 1 is thus more convenient and more interesting.

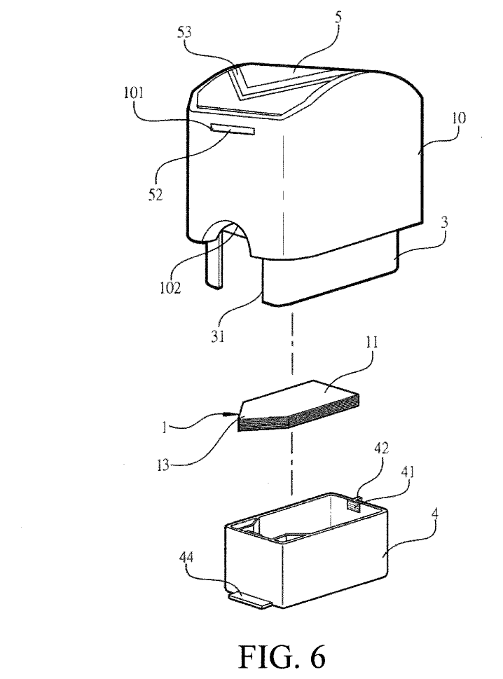

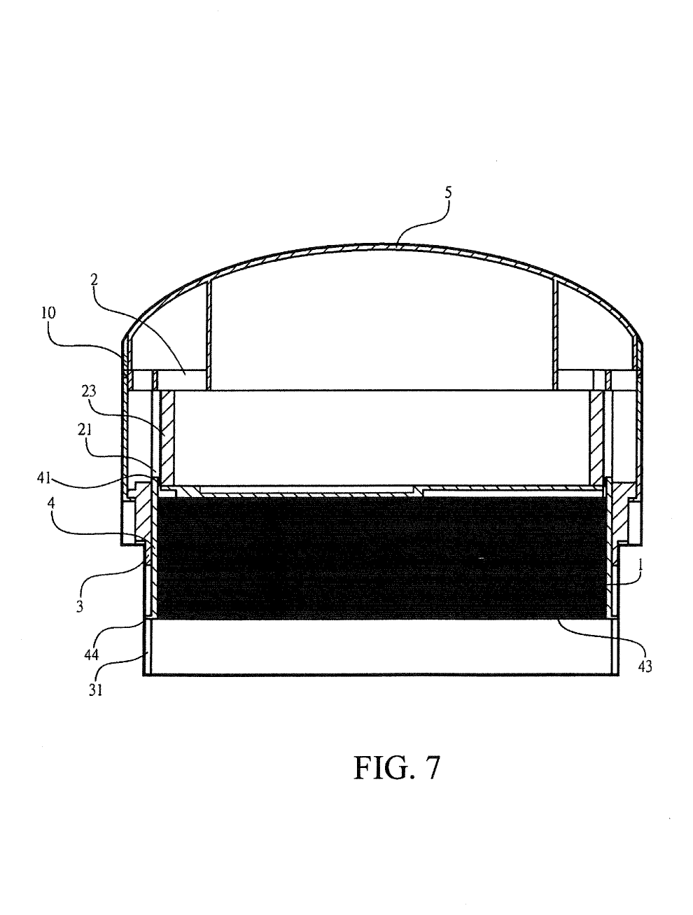

Referring to FIGS. 6 and 7, which are schematic views illustrating disposition of stickers according to the present invention, reference being also had to FIG. 2, as shown in the drawings, in a state that the present invention is not in use, the movable seat 3 is biased by the spring force of the elastic elements 34 to expose on the bottom of the machine body 10, and therefore, the sticker tray 4 is set in a state of being inwardly retracted in the movable seat 3. To use, the movable seat 3 is forced upwards to have the sticker tray 4 exposed out of the movable seat 3. The sticker tray 4 can then be pulled out of and removed from the movable seat 3 for deposition of stacked signature stickers 1 therein (where the tip portion 13 of the signature stickers 1 is on the same direction as the arrow mark 53 of the top cover 5). In this, as the sticker tray 4 is set to have the toothed portions 41 engaging with the two toothed racks 23 of the stationary seat 2, the sticker trays 4 can be pulled to move out, and since the lower edges of the machine body 10 and the movable seat 3 are respectively formed with the notches 102 and the openings 31, hand holding the sticker tray 4 is made easy. After the deposition of the signature sticker 1, the sticker tray 4 is re-fit into the movable seat 3, and with the toothed portions 41 engaging with the two toothed racks 23, re-positioning is achieved. The movable seat 3 is returned to the state of being exposed out of the bottom of the machine body 10 as being acted upon by the elastic elements 34.

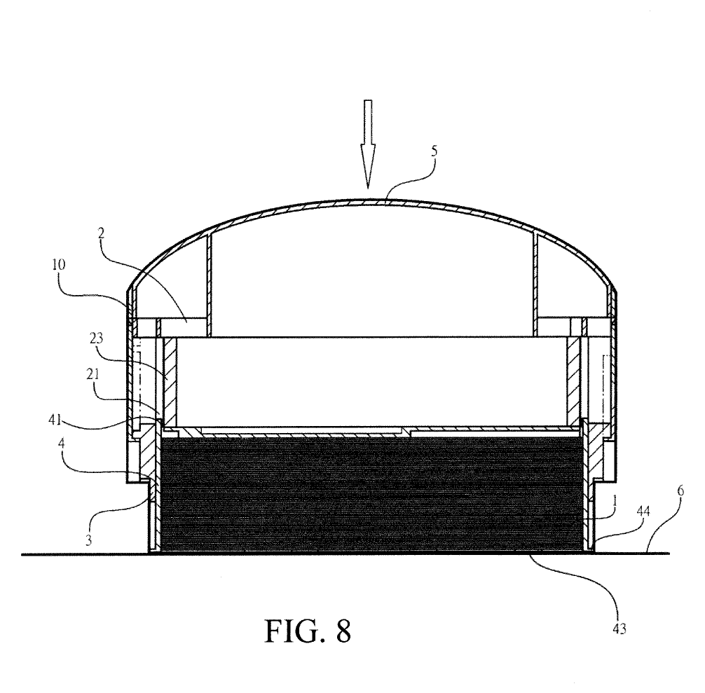

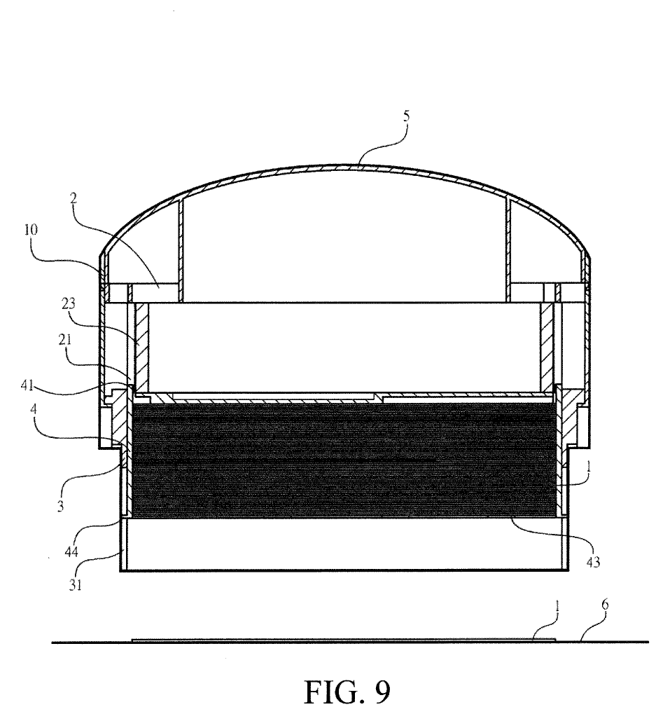

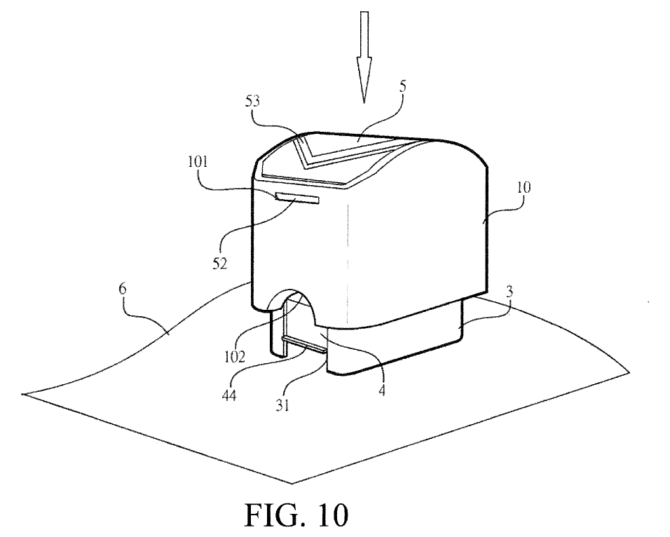

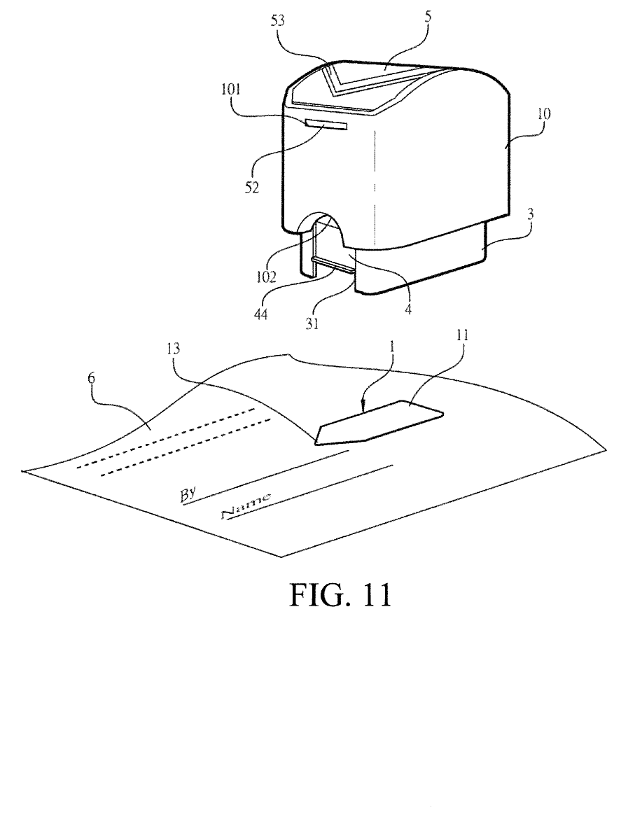

Referring to FIGS. 8 and 9, in combination with FIGS. 10 and 11, which are schematic views illustrating operation of the present invention, reference being also had to FIG. 1, as shown in the drawings, to use the present invention, the bottom of the movable seat 3 is placed against an object 6 to which a signature sticker 1 is to be stuck thereto, with the arrow mark 53 of the top cover 5 pointing to a signature location on the object 6. A hand may then press down the machine body 10 to cause the movable seat 3 to move upwards relative thereto to thereby have the sticker tray 4 protrude out of the bottom of the movable seat 3 to stick and attach the signature sticker 1 to a desired location of sticking, wherein the constraining portions 43 help separate the signature sticker 1 so stuck and attached from the other signature stickers 1, thereby fulfilling the operation of sticking the sticker in such a way as an operation stamping a seal.

When the hand is pressing down the machine body 10, the movable seat 3 is caused to move upwards relative thereto to thereby have the sticker tray 4 protrude out of the bottom of the movable seat 3 (wherein the toothed portions 41 in the sticker tray 4 slide down along the two toothed racks 23 to be then re-positioned), and the bottommost one of the signature stickers 1 is stuck, by means of the glue spots 121 of the glue application layer 12, to the object 6. When the machine body 10 is then released, the sticker tray 4 restores the inwardly retracted state due to the spring force of the elastic elements 34. As the top of the signature sticker 1 is the marking layer 11, and the sticker tray 4 is provided, on the inner sides of the bottom thereof, with a plurality of constraining portions 43 that are inwardly extended horizontally for a predetermined length, the signature sticker 1 that is stuck and attached to the object 6 moves across the constraining portions 43 to thereby separate from the signature stickers 1 remaining in the sticker tray 4, so that a single one of the signature stickers 1 is stuck and attached to the object 6, on which a location that is indicated by the tip portion 13 of the stuck signature sticker 1 is the location where a signature is to be placed, this providing an indication to the signature site of the object 6. As such, the use of the signature sticker 1 is more convenient and more interesting.

For the use of the signature stickers 1 described above, since the signature stickers 1 can be set with different colors, the signature stickers 1 of different colors can be set in different ones of the sticker trays 4, so that different colors of the signature stickers 1 can be used by different signers or for different documents, such as red color for general manager, blue color for manger, and green color for deputy manager. In this way, the utilization of the signature sticker 1 is more practical. Further, after the signature sticker 1 is stuck and attached, it is feasible to put down the name of the person to make the signature or other reminder messages on the marking layer 11 of the signature sticker 1 as desired so as to clearly mark the signature location for each person of which the signature is to be made.

I claim:

1. A stamp-fashion signature sticker machine structure, comprising:
a machine body, which is provided with a notch of a semi-circular shape formed in a lower edge of each of two ends thereof, and has a top on which a top cover is arranged;
a stationary seat, which is arranged in an interior of the machine body and is provided with a pressing portion, a fitting groove being formed in each of two ends of the pressing portion, two toothed racks being respectively arranged in the fitting grooves, two sides of the stationary seat being each provided with a positioning notch portion;
a movable seat, which is fit to the pressing portion of the stationary seat and is made in the form of a frame having two sides each provided with a flange portion extending outwards by a predetermined with, two ends of the flange portion being each formed with a groove, two elastic elements being respectively arranged on the flange portions of the movable seat and each having a successively folded configuration having a bottom fixed to a respective one of the flange portions of the movable seat and positioned by the grooves on the two ends of the flange portion, tops of the elastic elements being respectively supported on the positioning notch portions of the stationary seat;
a sticker tray, which is fit to the movable seat and is movable upwards/downwards along the movable seat and is provided with a toothed portion formed an inner edge of each of two ends thereof, the toothed portions engaging with the toothed racks of the stationary seat, a plurality of constraining portions being formed on an inner edge of a bottom of each of two sides and extending horizontally inwards; and
signature stickers, which are stacked and receive in the sticker tray, each having a marking layer arranged on a surface thereof and a glue application layer arranged on a bottom thereof, the glue application layer being formed as a uniformly distributed glue application layer; wherein by pressing down the machine body, the movable seat is caused to move upwards relatively to have the sticker tray to protrude out from the bottom of the movable seat so as to have a bottommost one of the signature stickers stuck and attached to an object, and the constraining portions cause the stuck and attached signature sticker to separate from remaining ones of the signature stickers so as to achieve a sticking and attaching operation of the signature sticker in a way similar to stamping a seal.

2. The stamp-fashion signature sticker machine structure according to claim 1, wherein the movable seat is provided with an opening formed in a lower edge of each of two ends thereof; the sticker tray is provided with a stop plate formed in an outer edge of each of the two ends thereof and extending outwards, the stop plates being received in the openings for position constraining.

3. The stamp-fashion signature sticker machine structure according to claim 2, wherein the movable seat is provided with a sliding groove formed in an upper edge of the opening of one of ends thereof and extending vertically upwards from the opening; the sticker tray is provided with a positioning tab on an outer edge of one of the ends thereof, the positioning tab being received in the sliding groove for positioning for movement of the sticker tray.

4. The stamp-fashion signature sticker machine structure according to claim 1, wherein the machine body is provided with a fixing hole formed in each of two ends thereof and adjacent to a top edge, and the top cover is provided with a retention hook formed on each of two ends thereof, the retention hooks being respectively engageable with the fixing holes to fix the top cover.

5. The stamp-fashion signature sticker machine structure according to claim 1, wherein the glue application layer of the signature stickers is provided with uniformly distributed glue spots.

6. The stamp-fashion signature sticker machine structure according to claim 5, wherein the glue spots of each of the signature stickers are arranged at a different angle, such that the different angles of upper and lower signature stickers make the glue spots thereof sifted away from each other for easing stacking and separation.

7. The stamp-fashion signature sticker machine structure according to claim 5, wherein the signature stickers are set with different colors so that different signature makers are allowed to use the signature stickers of different colors.
